(19) United States
(12) Patent Application Publication
(10) Pub. No.: US 2006/0026455 A1
(43) Pub. Date: Feb. 2, 2006

(54) Information storage medium, recording/reproducing apparatus and recording/reproducing method

(75) Inventors: Sung-hee Hwang, Seoul (KR); Jung-wan Ko, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/156,574

(22) Filed: Jun. 21, 2005

(30) Foreign Application Priority Data
Jul. 29, 2004 (KR) 2004-59747

(51) Int. Cl. G06F 11/00

(52) U.S. Cl. 714/5

(57) ABSTRACT

A write once information storage medium having original data, replacement data, updated data and management information recorded thereon and an apparatus for and a method of recording and managing the data and the management information. The management information includes a defect address, a replacement address and state information for distinguishing whether data at the replacement address replaces a defect encountered in the original data, a defect encountered in recording replacement data, or a defect encountered during updating of data by logical overwrite (LOW). Accordingly, by using state information to discriminate between replacement by LOW, replacement by defect during LOW and replacement by defect without LOW, data reproduction efficiency is increased in a system in which both replacement by LOW and replacement by defect are implemented.

### CROSS-REFERENCE TO RELATED PATENT APPLICATION

This application claims the benefit of Korean Patent Application No. 2004-59747, filed on Jul. 29, 2004, in the Korean Intellectual Property Office, the disclosure of which is incorporated herein by reference.

### BACKGROUND OF THE INVENTION

1. Field of the Invention

Aspects of the present invention relate to a disc, and more particularly, to an information storage medium for managing replacement by defect and replacement by logical overwrite (LOW), a recording/reproducing apparatus therefor and a recording/reproducing method thereof.

2. Description of the Related Art

For rewritable information storage media, a spare area is usually reserved in the data area. If a defect is detected while user data are being recorded in a user data area (the area obtained by excluding the spare area from the data area), or if a defect is detected when data recorded in the user data area are being reproduced, replacement data are recorded in the spare area to replace the defective data.

For write-once information storage media, the above defect management method is used for a logical overwrite (LOW). LOW is a method of using the write-once information storage media to simulate the rewritable information storage media. That is, to update data already recorded in the user data area, data are recorded in the spare area to replace the recorded data by dealing with the recorded data as if the data to be updated were defect data. LOW makes management easy since it can appear to a host as if data in the user data area are overwritten at the original location by fixing the logical address of the data recorded in the user data area and assigning a physical address corresponding to the logical address to data recorded in the spare area, as long as the host refers to only the logical address.

However, another method suggests recording data updated by LOW implementation according to defect management in an un-recorded area of a user data area on a disc without being limited to the spare area, and generating replacement information (defect entry information) for the updated data, to maximize the use of disc capacity.

A detailed example will now be described with reference to FIGS. 1A and 1B. FIGS. 1A and 1B are reference diagrams illustrating logical overwrite for recording replacement data in a user data area according to a conventional method.

Referring to FIG. 1A, a data area includes a spare area (SA), a user data area and another SA in series, and data A are recorded from a beginning address of the user data area. When the data A which are already recorded in the user data area are updated, as shown in FIG. 1B, updated data A are recorded next to the data A to replace the data A recorded in the user data area. By recording data to replace data recorded in the user data area in an un-recorded area of the user data area, the data A and the updated data A exist in a physical volume space, and the updated data A exists in a logical volume space.

For write-once information storage media using a conventional defect management method in which LOW is not implemented, due to a characteristic of the write-once information storage media on which recording is performed only once, data recorded at a defect address of a defect entry indicating a replaced state, and data recorded at a replacement address indicate data having the same contents in reality. Where a reproduction command directing a logical address corresponding to the defect address of the defect entry is received from a host, a drive system may perform error correction of the data recorded at the replacement address corresponding to the defect address and transmit the error-corrected data to the host. Alternatively, if the data recorded at the replacement address cannot be error-corrected even if the drive system accesses the replacement address, the drive system accesses the defect address, performs error correction of the data recorded at the defect address if the error correction can be performed, and transmits the error-corrected data to the host. In other words, if the data recorded at both the defect address and the replacement address can be error-corrected, the drive system can transmit either the data recorded at the defect address or the data recorded at the replacement address to the host since the data recorded at the defect address and the data recorded at the replacement address are identical if both the data recorded at the defect address and the replacement data can be error-corrected.

However, as described above, since data can be logically updated in the write-once information storage media by using LOW, an assumption that the data recorded at the defect address of the defect entry and the data recorded at the replacement address are identical is no longer valid, even if the data can be error-corrected. The assumption is not valid because replacement data by LOW may be updated data for updating original data. Even for a system in which LOW is implemented, in the case of a defect entry indicating a replacement state not by LOW but by defect, data recorded at a defect address and data recorded at a replacement address will be still identical. Therefore, a scheme is required to increase data reproduction efficiency in a system in which LOW is implemented.

### SUMMARY OF THE INVENTION

An aspect of the present invention provides an information storage medium that enables an increase of data reproduction efficiency in a system in which both replacement by logical overwrite (LOW) and replacement by defect are implemented, a recording/reproducing apparatus using the same, and a recording/reproducing method using the same.

According to an aspect of the present invention, there is provided an information storage medium comprising: a user data area for recording user data; and a spare area for recording replacement data for updating original data recorded in the user data area and replacement data for replacing defect data occurred in the user data area, the replacement data for updating the original data recorded in the user data area can be also recorded in an unrecorded area of the user data area, and wherein state information for distinguishing the state of the replacement data for replacing the defect data occurred in the user data area from the state of the replacement data for updating the original data recorded in the user data area is recorded in a predetermined area arranged in the medium.

The state of the replacement data for updating the original data may include at least one of the state of replacing with data in the unrecorded area by a data write command with respect to a physically recorded area of the user data area, and the state of replacing a defect block in which a defect occurs during recording of data in the unrecorded area or by verifying after writing, with a block in another unrecorded area. (As used in this disclosure and in the appended claims, an expression of the form “at least one of A and B,” has the following meaning: A only or B only or A and B.)

The state of the replacement data for replacing the defect data may include the state of replacing defect data in which a defect is detected during recording of data in the unrecorded area by a data write command with respect to a physically unrecorded area of the user data area or by verifying after writing, with data in another unrecorded area.

A lead-in area and lead-out area are arranged in the medium and the state information may be included in a defect entry in a temporary defect list (TDFL) area provided in the lead-in area or the lead-out area, and the defect entry may include state information for distinguishing replacement and update, state information indicating whether a defect is consecutive, address information of the original data or the defect data, and address information of the replacement data.

According to another aspect of the present invention, there is provided a recording apparatus comprising: a write unit which records data on an information storage medium including a user data area for recording user data and a spare area for recording replacement data for updating original data recorded in the user data area and replacement data for replacing defect data occurred in the user data area, wherein the replacement data for updating the original data recorded in the user data area can be also recorded in an unrecorded area of the user data area; and a controller which controls the write unit to record state information for distinguishing the state of the replacement data for replacing the defect data occurred in the user data area from the state of the replacement data for updating the original data recorded in the user data area in a predetermined area arranged in the medium.

According to another aspect of the present invention, there is provided a reproducing apparatus comprising: a read unit which reads data from an information storage medium including a user data area for recording user data and a spare area for recording replacement data for updating original data recorded in the user data area and replacement data for replacing defect data occurred in the user data area, wherein the replacement data for updating the original data recorded in the user data area can be also recorded in an unrecorded area of the user data area; and a controller which controls the read unit to read state information for distinguishing the state of the replacement data for replacing the defect data detected in the user data area from the state of the replacement data for updating the original data recorded in the user data area from a predetermined area arranged in the medium, and reproduces of data with reference to the read state information.

If state information of data according to a reproduction command of a host has the state of the replacement data for replacing the defect data, and if reproduction of the replacement data fails and reproduction of the defect data succeeds, the controller may reproduce and transmit the defect data to the host.

If state information of data according to a reproduction command of a host has the state of the replacement data for updating the original data, and if reproduction of the replacement data fails, the controller may transmit a reproduction failure message to the host.

According to another aspect of the present invention, there is provided a recording method comprising: recording replacement data for updating original data recorded in a user data area in an unrecorded area of the user data area or a spare area arranged in an information recording medium, wherein the information storage medium includes the user data area for recording user data and the spare area for recording replacement data for updating original data recorded in the user data area and replacement data for replacing defect data generated in the user data area; and recording state information for distinguishing the state of the replacement data for replacing the defect data detected in the user data area from the state of the replacement data for updating the original data recorded in the user data area, in a predetermined area arranged in the medium.

According to another aspect of the present invention, there is provided a reproducing method comprising: reading data from an information storage medium including a user data area for recording therein user data and a spare area for recording replacement data for updating original data recorded in the user data area and replacement data for replacing defect data detected in the user data area, wherein the replacement data for updating the original data recorded in the user data area can be also recorded in an unrecorded area of the user data area; reading state information for distinguishing the state of the replacement data for replacing the defect data detected in the user data area from the state of the replacement data for updating the original data recorded in the user data area, from a predetermined area arranged in the medium; and reproducing data with reference to the state information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B are reference diagrams illustrating a logical overwrite of recording replacement data in a user data area according to a conventional method;

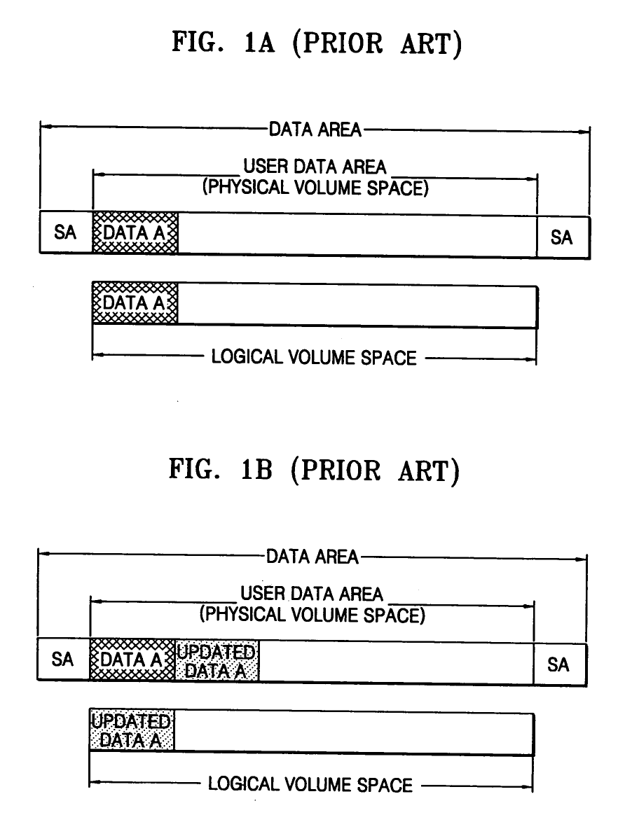

FIG. 2 is a block diagram of a recording/reproducing apparatus according to an embodiment of the present invention;

FIG. 3 is a detailed block diagram of the recording/reproducing apparatus shown in FIG. 2 FIG. 4 shows a structure of an information storage medium according to an embodiment of the present invention;

FIG. 5 shows a data structure of the defect entry shown in FIG. 4;

FIGS. 6A and 6B are reference diagrams illustrating replacement by LOW and replacement by defect applied to a disc according to an embodiment of the present invention;

FIGS. 7A through 7C are reference diagrams illustrating a method of managing defect entries in a disc in which both replacement by LOW and replacement by defect are performed according to an embodiment of the present invention;

FIG. 8 is a reference diagram illustrating an example of the method of managing defect entries in a disc in which both replacement by LOW and replacement by defect are performed according to an embodiment of the present invention;

FIG. 9 is a structural diagram of the defect entries generated according to states shown in FIG. 8;

FIG. 10 is a flowchart illustrating a data recording operation in a system in which both replacement by LOW and replacement by defect are performed according to an embodiment of the present invention; and

FIG. 11 is a flowchart illustrating a data reproducing operation in a system in which both replacement by LOW and replacement by defect are performed according to an embodiment of the present invention.

### DETAILED DESCRIPTION OF THE INVENTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

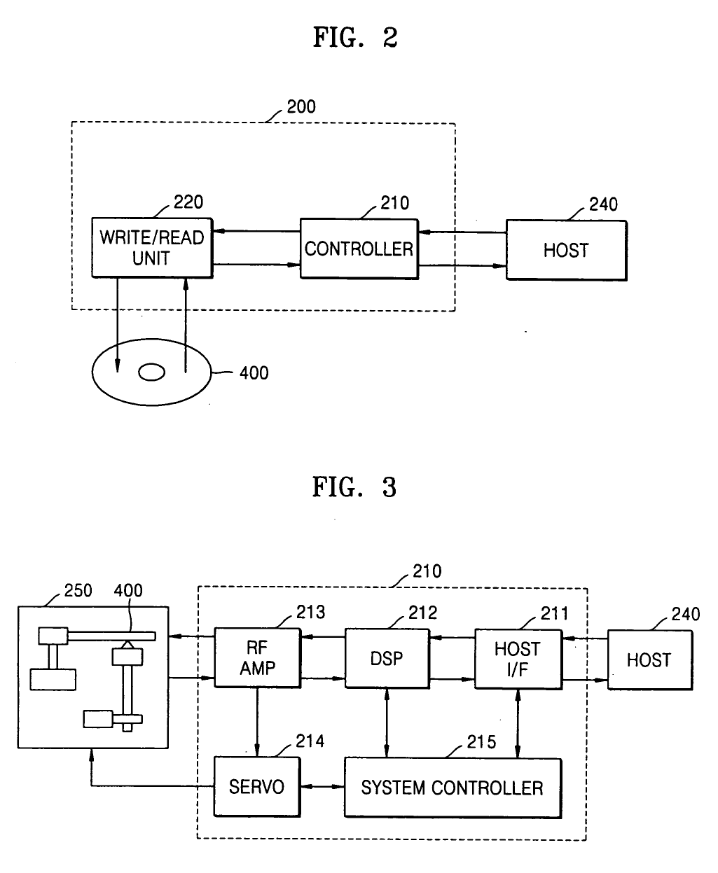

FIG. 2 is a block diagram of a recording/reproducing apparatus 200 according to an embodiment of the present invention. Referring to FIG. 2, the recording/reproducing apparatus 200 includes a write/read unit 220 and a controller 210. Under control of the controller 210, the write/read unit 220 records data on a disc 400, which is an information storage medium according to the present embodiment, and also reads and reproduces the recorded data. The controller 210 controls the write/read unit 220 to record data in blocks of a recording unit, or obtains valid data by processing read data using the write/read unit 220.

In a recording operation, the controller 210 controls the write/read unit 220 to record data by performing a logical overwrite (LOW) according to a command of a host 240 or control of the controller 210, and if a defect is detected during a data write or by verifying after write, the controller 210 controls the write/read unit 220 to record a replacement block for replacing the defect block in a spare area. Using LOW, updated data or replacement data recorded in a user data area of a write-once recording medium is recorded in a spare area or an un-recorded area of the user data area, and address information of the original data and the replacement data are managed so that the logical address is not changed in the point of view of the host 240. The controller 210 performs replacement by LOW and replacement by defect and generates defect entries for managing address information defect data and replacement data and state information of the defect data and record the generated defect entries in a lead-in area or a lead-out area of the disc 400. In the case of the replacement by defect, since the defect data and the replacement data are actually the same, when reproduction of the replacement data fails, if reproduction of original data is possible, the original data may be reproduced and transmitted to the host 240. In the case of the replacement by LOW, since the defect data are different from the replacement data, if the reproduction of the replacement data fails, a reproduction error message may be transmitted to the host 240 immediately after the failure. Therefore, management is necessary to determine whether a replacement state is associated with LOW or with a defect. The controller 210 generates defect entries to manage two kinds of replacement state information and records the replacement state information in the defect entries.

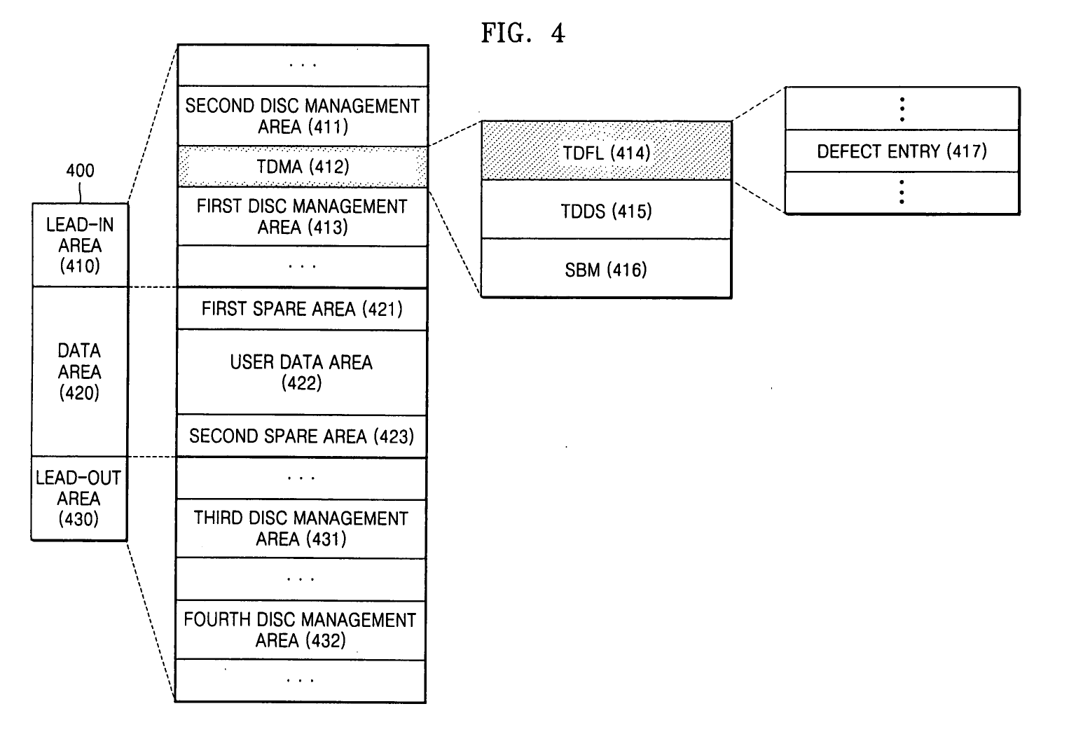

FIG. 3 is a detailed block diagram of the recording/reproducing apparatus 200 shown in FIG. 2. Referring to FIG. 3, the recording/reproducing apparatus 200 includes a pickup 250 as the write/read unit 220. The disc 400 is accessed by the pickup 250. The controller 210 includes a host interface (I/F) 211, a digital signal processor (DSP) 212, a radio frequency amplifier (RF AMP) 213, a servo 214 and a system controller 215.

In a recording operation, the host I/F 211 receives data to be recorded and a write command, together with logical address information of the data to be recorded, from the host 240, and transmits the write command and the logical address information to the system controller 215.

The system controller 215 receives the write command from the host I/F 211 and performs initialization required for recording. In particular, according to the present embodiment, if data are newly to be recorded in an unrecorded area, the system controller 215 controls the pickup 250 to record the data at an address to be recorded based on the write command, and if a defect is detected during a data write or by verifying after writing, the system controller 215 replaces a defect block in which the defect occurs with a replacement block in the spare area, generates a defect entry indicating the state of “replacement by defect,” and records the generated defect entry in a temporary defect list (TDFL) area of the disc 400. If data are updated, the system controller 215 records updated data in an un-recorded area of the user data area using a linear replacement method, generates a defect entry indicating a state of “replacement by LOW,” and records the defect entry in the TDFL area of the disc 400. If a defect is detected during a replacement data write by LOW or by verifying after writing, the system controller 215 replaces a defect block with a replacement block in the spare area, generates a defect entry indicating the state of “replacement by defect,” and records the generated defect entry in the TDFL area of the disc 400.

The DSP 212 adds additional data such as parity bits for error correction to the data to be written received from the host I/F 211, generates an error correction (ECC) block by performing ECC encoding on the data, and modulates the generated ECC block. The RF AMP 213 converts the data output from the DSP 212 to an RF signal. The pickup 250 writes the RF signal output from the RF AMP 213 onto the disc 400. The servo 214 receives a command required for servo control from the system controller 215 and servo-controls the pickup 250.

In a reproducing operation, the host I/F 211 receives a read command from the host 240. The system controller 215 performs initialization required for the reproduction. In particular, according to the present embodiment, the system controller 215 converts a logical address based on the read command to a physical address, seeks a replacement address from the defect entries based on the converted physical address, and reads data recorded at the replacement address. If a block in which error correction is impossible is detected from the read data, then if a defect entry corresponding to the block indicates the state of “replacement by LOW,” the system controller 215 transmits an error message to the host 240, and if the defect entry indicates the state of “replacement by defect” and a block of a defect address corresponding to the block in which error correction is impossible can be error-corrected, the system controller 215 performs error correction of the block of the defect address and transmits the error-corrected data to the host 240.

The pickup 250 radiates a laser beam onto the disc 400 and receives the reflected laser beam to obtain an optical output signal. The RF AMP 213 converts the optical signal output from the pickup 250 to an RF signal, provides modulated data obtained from the RF signal to the DSP 212, and provides a servo signal for control, obtained from the RF signal, to the servo 214. The DSP 212 demodulates the modulated data and outputs data obtained through ECC error correction.

The servo 214 performs the servo control of the pickup 250 based on the servo signal received from the RF AMP 213 and the command required for the servo control received from the system controller 215. The host I/F 211 transmits the data received from the DSP 212 to the host 240.

FIG. 4 shows a structure of an information storage medium according to an embodiment of the present invention. Referring to FIG. 4, a data structure 400 of data written on the write-once information storage medium includes a lead-in area 410, a data area 420 and a lead-out area 430. The lead-in area 410 includes a second disc management area 411, a temporary disc management area (TDMA) 412, and a first disc management area 413. The TDMA 412 is an area for recording information on temporary defect management and temporary disc management for managing the write-once information storage medium. The TDMA 412 includes a TDFL 414, a temporary disc definition structure (TDDS) 415 and a space bit map (SBM) 416. The TDFL 414 indicates information on temporary defects and includes location information of defect data and location information of replacement data for replacing the defect data. In particular, the TDFL414 includes a defect entry 417.

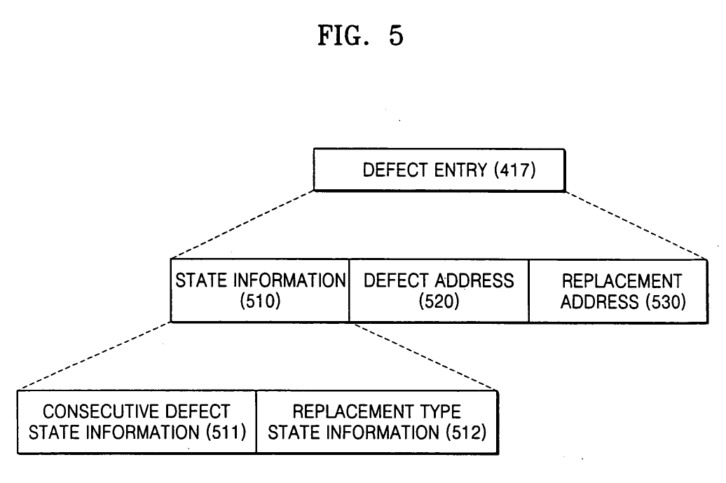

FIG. 5 shows a data structure of the defect entry 417 shown in FIG. 4. Referring to FIG. 5, the defect entry 417 includes state information 510, a defect address 520 and a replacement address 530. The state information 510 indicates state information on the defect entry 417. The state information 510 includes consecutive defect state information 511 and replacement type state information 512.

The consecutive defect state information 511 indicates whether the defect entry 417 is a consecutive defect entry, and if so, indicates whether the defect entry 417 is the beginning or ending entry of the consecutive defects. A single defect entry is a defect entry for managing defects in one block, and a consecutive defect entry is a defect entry for managing defects in more than two blocks. For the consecutive defect entry, consecutive defects may be efficiently managed by managing only defect entries for the beginning and end blocks of consecutive blocks in which defects occur, instead of generating defect entries for all those blocks. Values of the consecutive defect state information 511 and their significance are shown in Table 1 below.

TABLE 1

| Consecutive Defect State | |
|---|---|
| Information 511 | Significance |
| 00 | Single defect entry |
| 01 | Beginning entry of consecutive defect entry |
| 10 | End entry of consecutive defect entry |

The replacement type state information 512 indicates whether the defect entry 417 is generated due to LOW or a defect detected during LOW, or generated due to a defect detected during a write without LOW. In the case of replacement by LOW or by a defect during LOW, since replacement data has contents in which original data are updated, the contents of the replacement data and the original data are different from each other. In the case of replacement by defect during a write without LOW, since replacement data are generated to replace the original defective data at another location, not because the original data are updated, the contents of the replacement data and the original data are equal to each other. Values of the replacement type state information 512 and their significance are shown in Table 2 below.

TABLE 2

| Replacement Type State | |
|---|---|
| Information 512 | Significance |
| 0 | Defect entry by LOW or a defect during LOW |
| 1 | Defect entry by a defect during a write |
| | without LOW |

The defect address 520 indicates the beginning sector address of a defect block, and the replacement address 530 indicates the beginning sector address of a replacement block. This is because replacement is performed in block units, i.e., recording/reproducing units, and a replaced state is indicated in block units in drive systems.

The TDDS 415 includes location pointers of the TDFL 414, the SBM 416 and a drive area, as well as location and size information of spare areas assigned in an initializing operation, write protection information, location and size information of a temporary defect management area assigned in the data area 420, information on a user data area 422, information on a replaceable location in each spare area, and a last recording address in the user data area 422.

The SBM 416 is a map indicating whether the user data area 422 is written, by representing whether each cluster of the user data area 422 is written using a bit value. The SBM 416 is used when the user data area 422 is used in a random recording mode, and recording management information indicating a data recording state as entry information is used when the user data area 422 is used in a sequential recording mode. A first disc management area 413, a second disc management area 411, a third disc management area 431 and a fourth disc management area 432 are areas in which to record final disc management information when the write-once information storage medium is finalized. The data area 420 sequentially includes a first spare area 421, the user data area 422 and a second spare area 423.

The first and second spare areas 421 and 423 are areas for recording replacement data for replacing data recorded in the user data area 422. In the first and second spare areas 421 and 423, replacement data by defect or replacement data by LOW can be recorded. The user data area 422 is an area for recording user data. In particular, according to the present embodiment, replacement data by LOW for replacing user data are recorded in the spare areas 421 and 423 and the user data area 422.

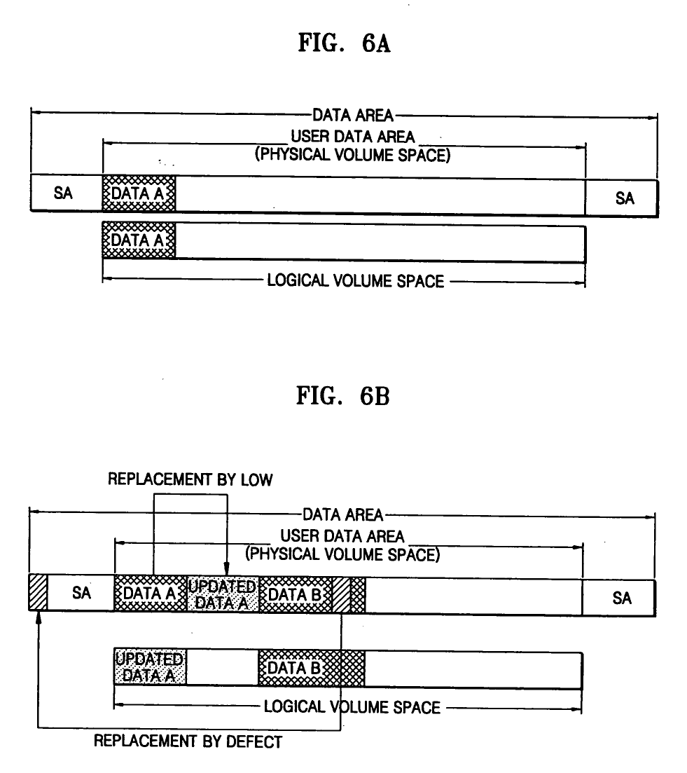

FIGS. 6A and 6B are reference diagrams illustrating replacement by LOW and replacement by defect applied to a disc according to an embodiment of the present invention. In the disc according to the present embodiment, both the replacement by LOW and the replacement by defect are performed.

Referring to FIG. 6A, a data area sequentially includes a spare area (SA), a user data area and another SA. Data A are recorded in a physical volume space of the user data area. FIG. 6B shows a state of the disc after recording of updated data A and recording new data B.

Referring to FIG. 6B, the updated data A are recorded in the user data area next to the original data A by LOW in the physical volume space (replacement by LOW). For the replacement by LOW, the updated data A are used to replace the contents of the data A, and since the contents of the updated data A are different from the contents of the original data A, the original data should not be reproduced even if the updated data cannot be reproduced.

The new data B are recorded next to the updated data A in the physical volume space. If a defect is detected in a certain block of the new data B during writing or verifying after writing, a replacement block for replacing the defect block of the new data B are recorded in the SA (replacement by defect). For the replacement by defect, since the replacement data recorded in the SA are generated by rerecording the same data due to the defect of the data B recorded in the user data area, if the replacement data recorded in the SA cannot be reproduced and the original data (data B) in the user data area can be reproduced, the original data may be reproduced and used.

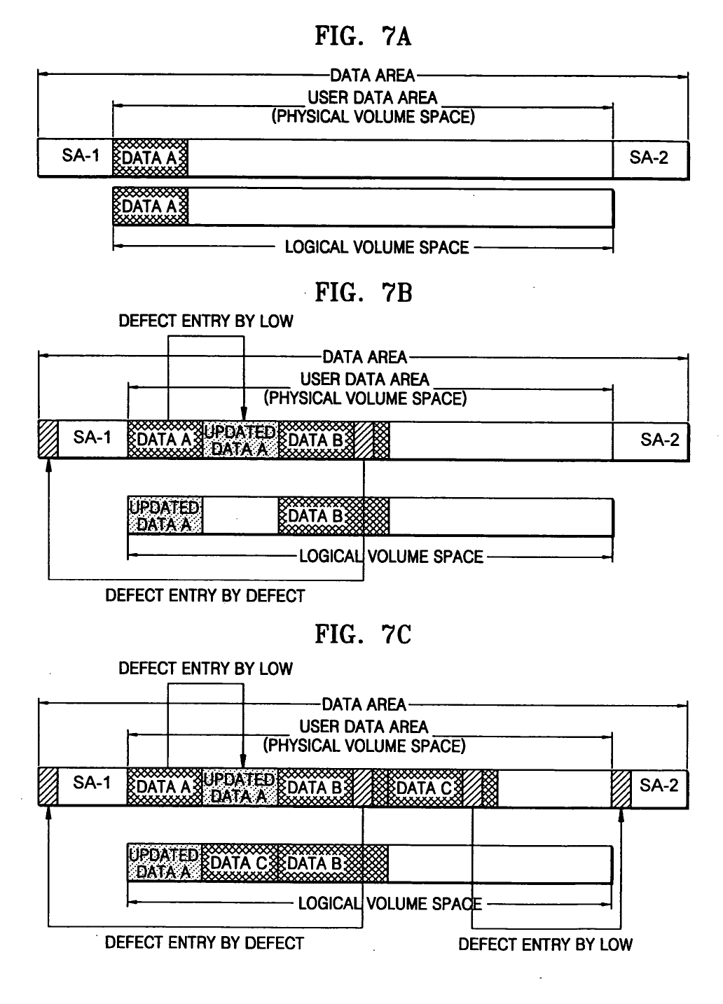

FIGS. 7A through 7C are reference diagrams illustrating a method of managing defect entries in a disc in which both replacement by LOW and replacement by defect are performed. Referring to FIG. 7A, data A are recorded in a physical volume space of the user data area. FIG. 7B shows a state of the disc after recording updated data A and recording new data B.

Referring to FIG. 7B, when the updated data A are recorded in the user data area next to the data A by LOW in the physical volume space, a defect entry by LOW is generated to manage this replacement state. The new data B are recorded next to the updated data A in the physical volume space. When a defect is detected in a certain block of the new data B during writing or verifying after writing, and thus a replacement block for replacing the defect block of the new data B is recorded in the SA-1, a defect entry by defect is generated to manage this replacement state.

FIG. 7C shows the state of the disc after further recording new data C. Referring to FIG. 7C, if a write command for recording the data C at a location between the data A and the data B in a logical volume space is received from a host, then since the updated data A are already recorded at the location of the physical volume space corresponding to the location of the logical volume space, the drive system should perform the replacement by LOW to record the data C in the physical volume space. Accordingly, if a defect is detected in the data C while writing the data C at a location next to the data B in the physical volume space or by verifying after writing, the drive system records a replacement block for replacing a defect block of the data C in an SA-2 and generates a defect entry by LOW to manage this replacement state.

In summary, the defect entry by LOW is a defect entry indicating the state of the replacement due to the update of the data A, the replacement by the drive system according to the write command of the host for the physically already recorded area such as writing the data C, or the replacement of the defect block generated in the replacement write. In other words, for the defect entry by LOW, even if both data recorded at a defect address and data recorded at its replacement address can be error-corrected, the contents of data recorded at the defect address and the contents of data recorded at the replacement address are not necessarily the same. Accordingly, when a read command for the defect address indicated by the defect entry by LOW (this is represented by state information of the defect entry) is received, the drive system should transmit data recorded at the replacement address indicated by the defect entry by LOW to the host after error correction of the data. If the data recorded at the replacement address cannot be error-corrected despite continuous tries, the drive system should not transmit the data recorded at the defect address to the host, but should instead inform the host that the data cannot be reproduced. Transmitting the data recorded at the defect address to the host could provide wrong information to the host.

The defect entry by defect indicates the state of the replacement of a defect block when a defect occurs during a write according to a write command of the host for a physically un-recorded area such as the data B. For the defect entry by defect, as described above, since data recorded at a defect address and data recorded at its replacement address are identical, then if they can be error-corrected, the drive system can reproduce and transmit either one to the host, thereby providing correct information to the host and causing no problem.

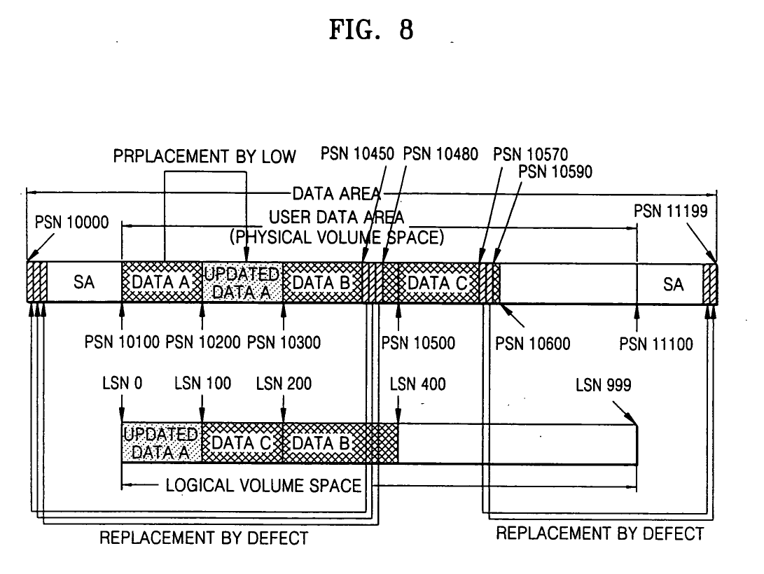

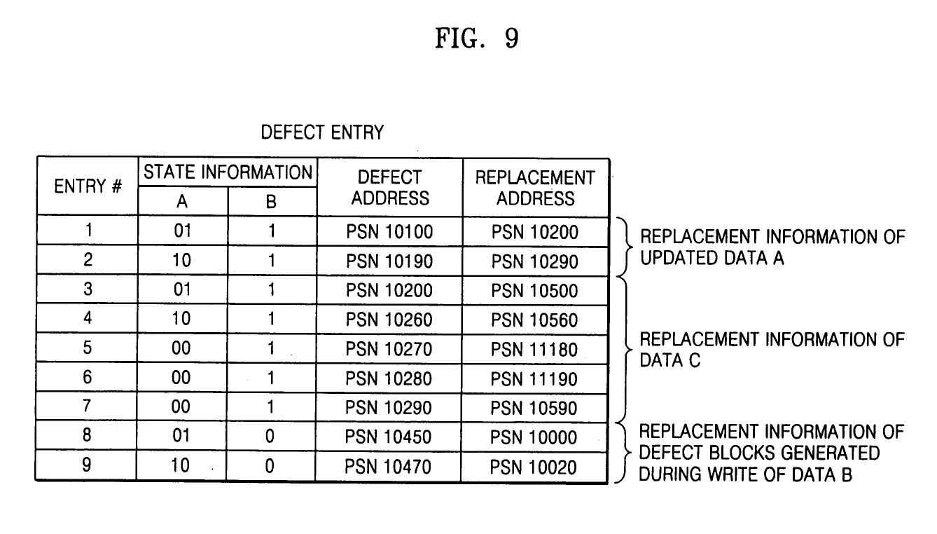

FIG. 8 is a reference diagram illustrating an example of the method of managing defect entries in a disc in which both replacement by LOW and replacement by defect are performed. FIG. 9 is a structural diagram of the defect entries generated according to states shown in FIG. 8.

FIG. 8 shows the physical state of the disc after recording data A, updated data A, data B and data C, the state of the replacement by LOW and the state of the replacement by defect.

In FIG. 9, nine defect entries are shown as examples. State information A indicates whether each defect entry is a consecutive defect entry, and if the defect entry is a consecutive defect entry, the state information A indicates whether the defect entry is a beginning entry or an end entry. State information B indicates replacement type state information indicating whether each defect entry is generated due to LOW or detected during LOW (e.g., A=1), or generated due to a defect detected during a write without LOW (e.g., A=0) Each defect address and replacement address of the defect entries indicates the beginning sector address of each block. Beginning sector addresses are used because replacement is performed in block units, i.e., recording/reproducing units, and replacement states are indicated in block units in the drive system. In FIG. 8, it is assumed that 1 block=10 sectors.

Referring to FIG. 8, when a host first commands the drive system to record data A at logical sector number (LSN) 0 to LSN 99, the drive system records the data A at physical sector number (PSN) 10100 to PSN 10199 corresponding to LSN 0 to LSN 99. When the host commands the drive system to record updated data A at LSN 0 to LSN 99 to update the data A, the drive system records the updated data A at PSN 10200 to PSN 10299, which are in an un-recorded area of the disc, using the linear replacement method based on the fact that data has already been recorded at PSN 10100 to PSN 10199 corresponding to LSN 0 to LSN 99, and generates an entry #1 indicating the beginning of consecutive defect entries (state information of the beginning entry A=01) and an entry #2 indicating the end of the consecutive defect entries (state information of the end entry A=10) in order to represent the replacement state as the consecutive defect entries. Here, since the entry #1 and the entry #2 are defect entries generated by LOW, they both have state information B=1.

When the host commands the drive system to record data B at LSN 200 to LSN 399, if defects are detected from three consecutive blocks of PSN 10450 to PSN 10479 while writing data B at PSN 10300 to PSN 10499 corresponding to LSN 200 to LSN 399 or by verifying after writing, the drive system replaces the three consecutive blocks of PSN 10450 to PSN 10479 with three blocks of PSN 10000 to PSN 10029 in an SA-1, and generates the beginning entry #8 and the end entry #9 of consecutive defect entries to indicate the consecutive replacement. Here, the entry #8 and the entry #9 have state information B=0 to indicate the state of replacement blocks by defect without LOW.

After the data B are recorded, when the host commands the drive system to record data C at LSN 100 to LSN 199, based on the fact that data has already been recorded at PSN 10200 to PSN 10299 corresponding to LSN 100 to LSN 199, if defects are detected from two blocks of PSN 10570 to PSN 10589 while writing the data C at PSN 10500 to PSN 10599, which are in an un-recorded area of the disc, as replacement or by verifying after writing, the drive system replaces the two blocks of PSN 10570 to PSN 10589 with two blocks of PSN 11180 to PSN 11199 in the SA-2, and generates entries #3 through #7 to indicate their replacement states. Since all of the entries #3 through #7 are generated by LOW or by defect during LOW, the entries #3 through #7 have state information B=1. The entries #3 and #4 are consecutive defect entries indicating the replacement state of blocks from the beginning block of the data C to the block just before a defect is generated in the data C recorded in the physical volume space. The entries #5 and #6 indicate the replacement state of two defect blocks in the data C recorded in the physical volume space. If defects were not generated in these two blocks, the two blocks would be replaced at PSN 10570 and PSN 10580 by LOW. However, since the two blocks are replaced at PSN 11180 to PSN 11190 in the SA-2 by defect, these addresses are recorded as the replacement addresses. The entry #7 indicates the replacement state of the last block recorded at PSN 10590, which is located next to the defect block, among the data C recorded in the physical volume space. The entries #3 and #4 indicate state information of the beginning entry and end entry of consecutive defect entries, respectively, and the entries #5 through #7 indicate state information of single defect entries. The entries #5 and #6 may be indicated as the beginning entry and the end entry of consecutive defect entries. Alternatively, the entries for two consecutive defect blocks may be indicated as two single defect entries.

Referring to FIG. 9, since the entries #1 through #7 have state information B=1, the data recorded at the defect addresses are different from the data recorded at the replacement addresses. Therefore, when the data are reproduced by the host, if the host commands the drive system to reproduce the data recorded at LSN 0 to LSN 99 to reproduce the updated data A, the drive system reproduces the data recorded at PSN 10200 to PSN 10299 and transmits the reproduced data to the host based on the fact that PSN 10100 to PSN 10199 corresponding to LSN 0 to LSN 99 are replaced with PSN 10200 to PSN 10299, as indicated by the defect entries #1 and #2. In this case, even if at least one block of PSN 10200 to PSN 10299 cannot be error-corrected, the drive system should not reproduce or transmit the data recorded at the address of the defect block to the host.

However, since the entries #8 and #9 have state information B=0, the data recorded at the defect addresses is identical to the data recorded at the replacement addresses. If the host commands the drive system to reproduce the data recorded at LSN 200 to LSN 399 to reproduce the data B, the drive system reproduces the data recorded at PSN 10300 to PSN 10499 corresponding to LSN 200 to LSN 399. In this case, since the three consecutive blocks of PSN 10450 to PSN 10479 are consecutively replaced with the blocks of PSN 10000 to PSN 10029 in the SA-1 by defect, the drive system reproduces the 15 blocks of PSN 10300 to PSN 10449 in the user data area, the three blocks of PSN 10000 to PSN 10029 in the SA-1, and then the remaining two blocks of PSN 10480 to PSN 10499 in the user data area. If any one of the three blocks of PSN 10000 to PSN 10029 replaced in the SA-1 cannot be error-corrected, the block at its defect address may be reproduced and transmitted to the host.

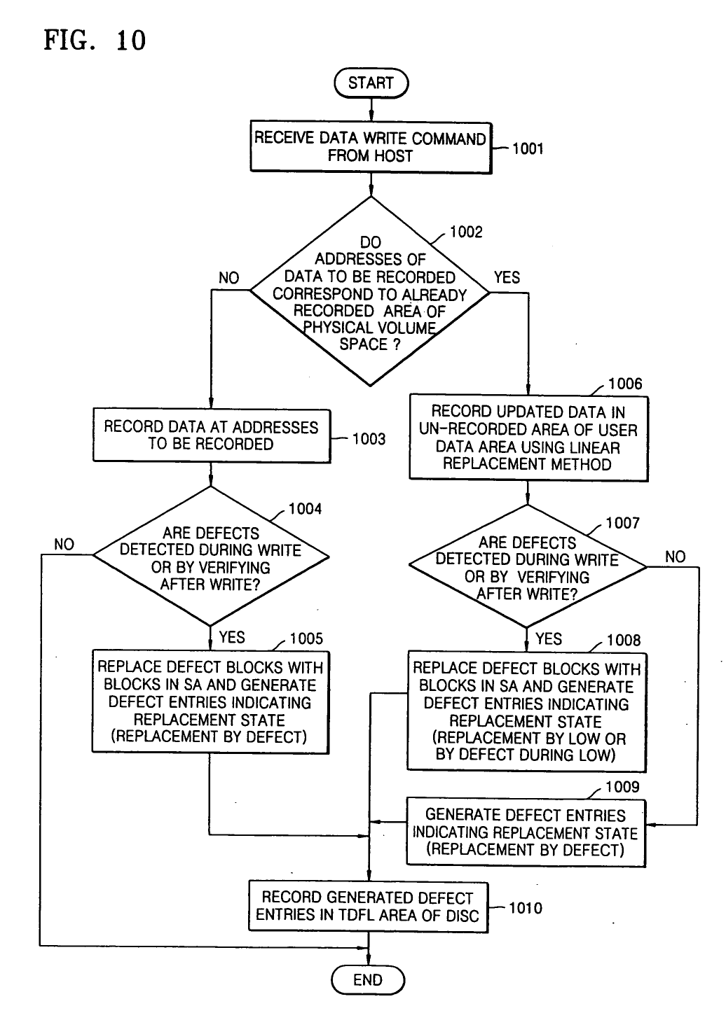

FIG. 10 is a flowchart illustrating a data recording operation in a system in which both replacement by LOW and replacement by defect are performed according to an embodiment of the present invention.

Referring to FIG. 10, a drive system receives a data write command from a host, in operation 1001. The drive system determines whether the addresses of data to be recorded according to the write command correspond to an already recorded area in a physical volume space, in operation 1002. The host transmits the write command with logical addresses, and the drive system converts the logical addresses to physical addresses and determines whether the physical addresses correspond to the already recorded area.

If the physical addresses do not correspond to an already recorded area, the data are recorded at the addresses to be recorded according to the write command in operation 1003. If defects are detected during writing the data or by verifying after writing, in operation 1004, the defective blocks are replaced with replacement blocks in an SA, defect entries indicating the state of replacement by defect are generated in operation 1005, and the generated defect entries are recorded in a TDFL area of the disc in operation 1010.

If the physical addresses correspond to the already recorded area (i.e., an update of already recorded data or an area not recorded as a logical volume space but recorded as a physical volume space), then updated data are recorded in an un-recorded area of a user data area using a linear replacement method in operation 1006. If defects are detected during writing or by verifying after writing, in operation 1007, the defect blocks are replaced with blocks in the SA and defect entries indicating the replacement states are generated, in operation 1008. In this case, the defect entries may have one of two states: replacement by LOW or replacement by defect during LOW. For state information of the defect entries, the replacement type related state information 512 shown in FIG. 5 is set to 1. The generated defect entries are recorded in the TDFL area of the disc in operation 1010.

If defects are not detected in operation 1007, defect entries indicating the state of the replacement by LOW are generated in operation 1009, and the generated defect entries are recorded in the TDFL area of the disc in operation 1010.

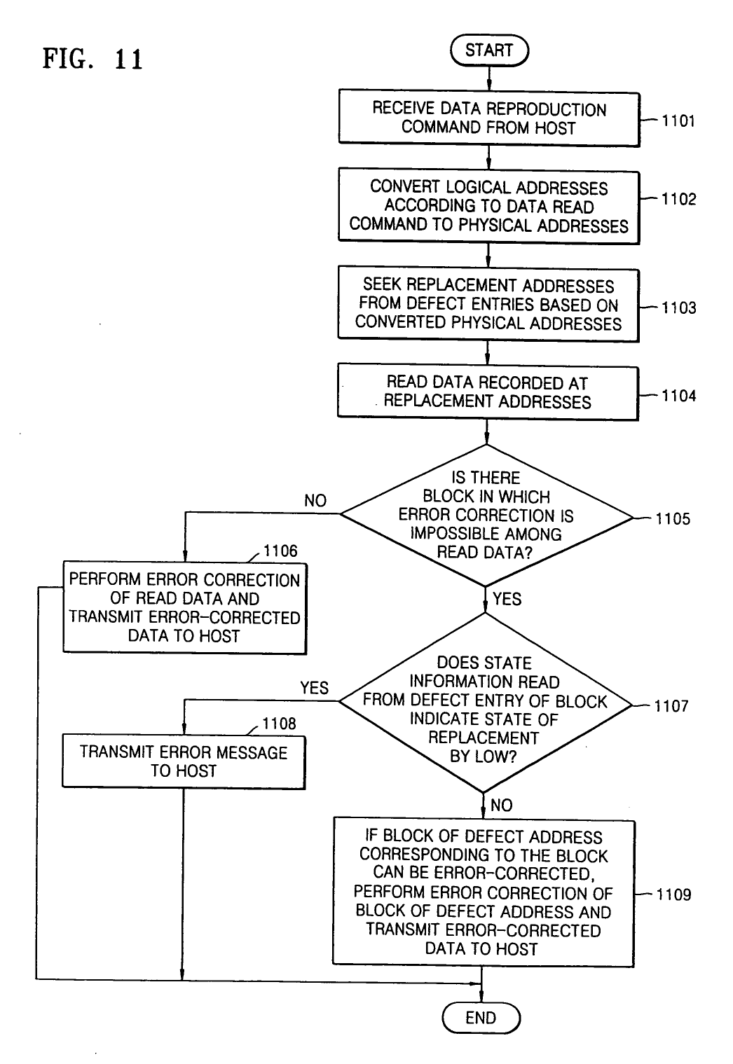

FIG. 11 is a flowchart illustrating a data reproducing operation in a system in which both replacement by LOW and replacement by defect are performed according to an embodiment of the present invention. Referring to FIG. 11, the drive system receives a data read command from a host in operation 1101. The drive system converts logical addresses of the data read command to physical addresses in operation 1102. The drive system seeks replacement addresses from defect entries based on the converted physical addresses in operation 1103.

Data recorded at the replacement addresses are read in operation 1104. If a block in which error correction is impossible is detected in operation 1105, it is determined whether state information read from a defect entry of the block indicates the state of replacement by LOW in operation 1107. If a state of replacement by LOW is indicated, the drive system transmits an error message to the host in operation 1108.

If the state information read from the defect entry of the block indicates the state of replacement by defect, then only if a block of defect addresses corresponding to the block can be error-corrected, the block of defect addresses is error-corrected and the error-corrected data are transmitted to the host in operation 1109.

If no block in which error correction is impossible is detected, the read data are error-corrected and transmitted to the host in operation 1106.

The embodiments of the present invention may be embodied as computer programs useable in general-use digital computers that execute the programs using a computer readable recording medium. Examples of the computer readable recording medium include magnetic storage media (e.g., ROM, floppy discs, hard discs, etc.), optical recording media (e.g., CD-ROMs, DVDs, etc.), and storage media such as carrier waves (e.g., transmission through the internet). The computer readable recording medium may also be distributed over network coupled computer systems so that the computer readable code is stored and executed in a distributed fashion. The functional programs, code and code segments for embodying the present invention may be implemented by programmers skilled in the art to which the embodiments of present invention relate.

As described above, according to embodiments of the present invention, by using state information to discriminate entries by LOW or defect during LOW from entries by defect without LOW, in a system in which both replacement by LOW and replacement by defect are implemented, the efficiency of data reproduction may be increased.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An information storage medium comprising:
a user data area for recording user data; and
a spare recording area, wherein:
replacement data for replacing defect data occurring in the user data area are recorded in the spare area,
replacement data for updating original data recorded in the user data area is recorded in the spare area or an unrecorded area of the user data area, and
state information for distinguishing a state of the replacement data for replacing the defect data from a state of the replacement data for updating the original data is recorded in a predetermined area of the medium.

2. The medium of claim 1, wherein the state of the replacement data for updating the original data includes at least one of a state of replacing with data in the unrecorded area by a data write command with respect to a physically recorded area of the user data area, and a state of replacing a defect block in which a defect occurs during recording of data in the unrecorded area or by verifying after writing, with a block in another unrecorded area.

3. The medium of claim 1, wherein the state of the replacement data for replacing the defect data includes a state of replacing defect data in which a defect is detected during recording of data in the unrecorded area by a data write command with respect to a physically unrecorded area of the user data area or by verifying after writing, with data in another unrecorded area.

4. The medium of claim 1, wherein:
a lead-in area and lead-out area are arranged in the medium and the state information is included in a defect entry in a temporary defect list (TDFL) area provided in the lead-in area or the lead-out area, and
the defect entry includes first state information for distinguishing the replacement data from the updated data, second state information indicating whether a defect is consecutive, address information of the original data or the defect data, and address information of the replacement data.

5. A recording apparatus comprising:
a write unit which records data on an information storage medium including a user data area for recording user data and a spare area, wherein replacement data for replacing defect data occurring in the user data area are recorded in the spare area and replacement data for updating original data recorded in the user data area are recorded in the spare area or an unrecorded area of the user data area; and
a controller which controls the write unit to record state information for distinguishing a state of the replacement data for replacing the defect data from a state of the replacement data for updating the original data in a predetermined area arranged in the medium.

6. The apparatus of claim 5, wherein the state of the replacement data for updating the original data includes at least one of a state of replacing with data in the unrecorded area by a data write command with respect to a physically recorded area of the user data area, and a state of replacing a defect block in which a defect is detected during recording of data in the unrecorded area or by verifying after writing, with a block in another unrecorded area.

7. The apparatus of claim 5, wherein the state of the replacement data for replacing the defect data includes a state of replacing defect data in which a defect is detected during recording of data in the unrecorded area by a data write command with respect to a physically unrecorded area of the user data area, or by verifying after writing with data in another unrecorded area.

8. The apparatus of claim 5, wherein:
the controller controls the write unit to write the state information in a defect entry in a temporary defect list (TDFL) area provided in a lead-in area or a lead-out area arranged in the medium, and
the defect entry includes first state information for distinguishing replacement data from update data, second state information indicating whether the defect data or the replacement data are consecutive, address information of the original data or the defect data, and address information of the replacement data.

9. A reproducing apparatus comprising:
a read unit which reads data from an information storage medium including a user data area for recording user data and a spare area, wherein replacement data for replacing defect data occurring in the user data area are recorded in the spare area and replacement data for updating original data recorded in the user data area is recorded in the spare area or an unrecorded area of the user data area; and
a controller which controls the read unit to read state information for distinguishing a state of the replacement data for replacing the defect data detected in the user data area from a state of the replacement data for updating the original data recorded in the user data area from a predetermined area of the medium, and reproduces corrected or updated data with reference to the read state information.

10. The apparatus of claim 9, wherein if state information of data according to a read command of a host has the state of the replacement data for replacing the defect data, and if reproduction of the replacement data fails but reproduction of the defect data succeeds, the controller reproduces and transmits the defect data to the host.

11. The apparatus of claim 9, wherein if state information of data according to a read command of a host has the state of the replacement data for updating the original data, and if reproduction of the replacement data fails, the controller transmits a reproduction failure message to the host.

12. The apparatus of claim 11, wherein the state of the replacement data for updating the original data includes at least one of a state of replacing with data in the unrecorded area by a data write command with respect to a physically recorded area of the user data area, and a state of replacing a defect block in which a defect is detected during recording of data in the unrecorded area or by verifying after writing, with a block in another unrecorded area.

13. A recording method comprising:
recording replacement data for updating original data recorded in a user data area in an unrecorded area of the user data area or a spare area arranged in an information recording medium;
recording replacement data for replacing defect data detected in the user data area in the spare area; and
recording state information for distinguishing a state of the replacement data for replacing the defect data detected in the user data area from a state of the replacement data for updating the original data recorded in the user data area, in a predetermined area of the medium.

14. The method of claim 13, wherein the state of the replacement data for updating the original data includes at least one of a state of replacing with data in the unrecorded area by a data write command with respect to a physically recorded area of the user data area, and a state of replacing a defect block in which a defect is detected during recording of data in the unrecorded area or by verifying after writing, with a block in another unrecorded area.

15. The method of claim 13, wherein the state of the replacement data for replacing the defect data includes a state of replacing defect data in which a defect is detected during recording of data in the unrecorded area by a data write command with respect to a physically unrecorded area of the user data area or by verifying after writing, with data in another unrecorded area.

16. The method of claim 13, wherein:
the state information is included in a defect entry in a temporary defect list (TDFL) area provided in a lead-in area or a lead-out area arranged in the medium, and
the defect entry includes state information for distinguishing replacement data from updated data, state information indicating whether replaced data or defect data are consecutive, address information of the original data or the defect data, and address information of the replacement data.

17. A reproducing method comprising:
reading data from an information storage medium having a user data area for recording user data or replacement data for updating original data recorded in the user data area and a spare area for recording replacement data for replacing defect data detected in the user data area;
reading state information for distinguishing a state of the replacement data for replacing the defect data detected in the user data area from a state of the replacement data for updating the original data recorded in the user data area, from a predetermined area arranged in the medium; and
reproducing data with reference to the read state information.

18. The method of claim 17, wherein if state information of data according to a read command of a host has a state of the replacement data for replacing the defect data, and if reproduction of the replacement data fails and reproduction of the defect data succeeds, then the reproducing of the data comprises reproducing the defect data.

19. The method of claim 17, wherein if state information of data according to a read command of a host has a state of the replacement data for updating the original data, and if reproduction of the replacement data fails, the method further comprises transmitting a reproduction failure message to the host.

20. The method of claim 19, wherein the state of the replacement data for updating the original data includes at least one of a state of replacing with data in the unrecorded area by a data write command with respect to a physically recorded area of the user data area, and a state of replacing a defect block in which a defect is detected during recording of data in the unrecorded area or by verifying after writing with a block in another unrecorded area.

21. An information storage medium comprising:
a first recording area recording first data;
a second recording area recording second data; and
a third recording area recording:
third data indicating a portion of the first data to be replaced by the second data,
fourth data indicating whether the second data updates the portion of the first data or corrects a defect in the portion of the first data, and
fifth data indicating a location of the second data.

22. The medium of claim 21, wherein the first data are original user data or additional user data recorded after the original user data.

23. The medium of claim 22, wherein the second data are recorded in the first recording area.

24. The medium of claim 21, wherein the second data are recorded in a fourth recording area exclusive of the first recording area.

25. The medium of claim 21, further comprising:
sixth data which indicates whether the portion of the first data to be replaced is recorded in a single recording unit or recorded in a plurality of recording units.

26. The medium of claim 21, wherein the third data and the fifth data identify a location of a recording unit including the portion of the first data to be replaced and a location of the second data.

27. The medium of claim 21, wherein:
the third data identifies beginning and ending locations of recording units including the portion of the first data to be replaced, and
the fifth data identifies beginning and ending locations of recording units including the second data.

28. A method of reproducing data from a recording medium having original data, update data changing the original data and/or corrective data for correcting a defect in the recording of the original data, the method comprising:
identifying the original data to be reproduced;
reading a table in a predetermined area of the recording medium to determine whether the update data or the corrective data has been recorded for the original data;
error correcting the original data as modified by the update data or the corrective data, and outputting the modified data, if the error correction of the modified data is successful;
error correcting the original data and outputting the original data, if the error correction of the modified data is not successful, the error correction of the original data is successful, and the reading of the table indicates that the original data are modifiable by the corrective data; and
generating an error message and not outputting either the original data or the modified data, if the reading of the table indicates that the original data are modifiable by the update data and the error correction of the modified data is not successful.

29. A method of recording update data for changing original data and/or corrective data for correcting a defect in recording of the original data, the method comprising:
recording the update data or the corrective data on the recording medium;
recording a table comprising:
first data indicating a portion of the original data to be modified by the update data or the corrective data,
second data indicating whether the original data are to be updated or corrected, and
third data indicating a location of the recorded update data or the recorded corrective data.

30. The medium of claim 29, further comprising:
fourth data which indicates whether the portion of the original data to be replaced is recorded in a single recording unit or recorded in a plurality of recording units.

31. The medium of claim 29, wherein the first data and the third data identify a location of a recording unit including the portion of the original data to be replaced and a location of the update data or the corrective data.

32. The medium of claim 29, wherein:
the first data identifies beginning and ending locations of recording units including the portion of the original data to be replaced, and
the third data identifies beginning and ending locations of recording units including the update data or the corrective data.

33. The medium of claim 4, further comprising:
a temporary disc definition structure which identifies a location and size of the TDFL area and a location and size of the spare recording area.

34. A method of managing recording of data on a write once disc having original data recorded thereon, the method comprising:
writing additional data to the disc, the additional data comprising:
first corrective data with respect to at least a portion of the original data where a defect is detected in the original data,
update data to logically overwrite at least a portion of the original data where the original data is to be updated, or
second corrective data with respect to at least a portion of the update data where the update data is written to the disc and a defect is detected in the writing of the update data; and
writing state information to the disc, the state information having a first value where the additional data is the first corrective data or a second value where the additional data is the update data or the second corrective data.

35. The method of claim 34, further comprising:
writing other original data to the disc; and
writing third corrective data with respect to at least a portion of the other original data and writing the state information having the first value to the disc where a defect is detected in the writing of the other original data.
